(19) United States
(12) Patent Application Publication
(10) Pub. No.: US 2024/0058933 A1
(43) Pub. Date: Feb. 22, 2024

(54) CHISEL

(71) Applicant: MILWAUKEE ELECTRIC TOOL CORPORATION, Brookfield, WI (US)

(72) Inventors: Joseph D. Greaney, Milwaukee, WI (US); Travis J. DuMez, Port Washington, WI (US); Vaishnav Vijay Mayekar, Milwaukee, WI (US)

(21) Appl. No.: 18/453,365

(22) Filed: Aug. 22, 2023

Related U.S. Application Data
(60) Provisional application No. 63/399,910, filed on Aug. 22, 2022.

(51) Int. Cl. B25D 17/02

(52) U.S. Cl. CPC B25D 17/02; B25D 2250/111; B25D 2222/42

(57) ABSTRACT

A chisel includes a body formed of a first material and including a first end having a shank and a second end. The second end includes a first planar side that defines a first plane, a second planar side that defines a second plane, a third side, and a fourth side. The body includes a channel formed in an edge of the second end between the first planar side and the second planar side and extends from the third side to the fourth side. The body includes a longitudinal axis extending through the first and second ends. The chisel includes a head formed of a second material that is harder than the first material. The head is received in the channel and positioned between the first and second planes. The head extends continuously between the third side and the fourth side to define a working surface of the chisel.

### CROSS-REFERENCE TO RELATED APPLICATION

This application claims priority to co-pending U.S. Provisional Patent Application No. 63/399,910, filed Aug. 22, 2022, the entire contents of which are incorporated by reference herein.

### FIELD OF THE INVENTION

The present invention relates to chisels.

### SUMMARY OF THE INVENTION

The present invention provides, in one aspect, a chisel including a body formed of a first material and having a first end having a shank and a second end. The second end includes a first planar side that defines a first plane and a second planar side that is opposite the first planar side and defines a second plane, a third side extending between the first planar side and the second planar side, and a fourth side that is opposite the third side and extending between the first planar side and the second planar side. The body includes a channel formed in an edge of the second end between the first planar side and the second planar side and extends from the third side to the fourth side. The body includes a longitudinal axis extending through the first end and the second end. The chisel includes a head formed of a second material that is harder than the first material and is received in the channel between the first and second planes. The head extends continuously between the third side and the fourth side and defines a working surface of the chisel.

The present invention provides, in another aspect, a chisel including a body formed of a first material and including having a first end having a shank and a second end. The second end includes a first planar side that defines a first plane, a second planar side that is opposite the first planar side and defines a second plane, a third side extending between the first planar side and the second planar side, and a fourth side that is opposite the third side and extending between the first planar side and the second planar side. The body includes a recess formed in the second end between the first plane and second plane. The body includes a longitudinal axis extending through the first end and the second end. The chisel includes a plate formed of a second material that is harder than the first material. The plate is received in the recess between the first and second planes and defines a working surface of the chisel.

The present invention provides, in yet another aspect, a chisel including a body formed of a first material. The body includes a first end having a shank, a second end opposite the first end, and a longitudinal axis extending through the first end and the second end. The second end defines a bore extending in a direction toward the first end along the longitudinal axis. The second end also defines a first working surface of the chisel. The chisel includes a first member formed of a second material that is harder than the first material. The first member is positioned within the bore and defines an aperture. The first member defines a second working surface of the chisel. The chisel includes a second member formed of a third material that is harder than the first material. The second member is positioned within the aperture and defines a third working surface of the chisel.

Other features and aspects of the invention will become apparent by consideration of the following detailed description and accompanying drawings.

### BRIEF DESCRIPTION OF THE DRAWINGS

FIG. 1 is perspective view of a chisel according to one embodiment, the chisel including a body and a head coupled to the body.

FIG. 2 is an exploded view of the chisel of FIG. 1.

FIG. 3 is a cross-sectional view of the chisel of FIG. 1 along the line 3-3 of FIG. 1.

FIG. 4 is a front view of the chisel of FIG. 1.

FIG. 5 is a cross-sectional view of the chisel of FIG. 1 along the line 5-5 of FIG. 1.

FIG. 6 is a detailed side view of the chisel of FIG. 1.

FIG. 7 is a detailed perspective view of the chisel of FIG. 1.

FIG. 8 is another detailed perspective view of the chisel of FIG. 1.

FIG. 9 is a detailed perspective view of a portion of the head of the chisel of FIG. 1.

FIG. 10 is a detailed perspective view of a portion of the head of chisel of FIG. 1.

FIG. 11 is a detailed side view of the body of FIG. 1.

FIG. 12 is a detailed side view of a portion of the head of FIG. 1.

FIG. 13 is a detailed side view of a portion of the head of FIG. 1.

FIG. 14 is perspective view of a chisel according to another embodiment, the chisel including a body and a head coupled to the body.

FIG. 15 is an exploded view of the chisel of FIG. 14.

FIG. 16 is a cross-sectional view of the chisel of FIG. 14 along the line 16-16 of FIG. 14.

FIG. 17 is a front view of the chisel of FIG. 14.

FIG. 18 is a detailed side view of the chisel of FIG. 14.

FIG. 19 is a detailed perspective view of the chisel of FIG. 14.

FIG. 20 is a detailed perspective view of the body of FIG. 14.

FIG. 21 is a detailed perspective view of the head of the chisel of FIG. 14.

FIG. 22 is a detailed side view of the body of FIG. 14.

FIG. 23 is a detailed side view of the head of FIG. 14.

FIG. 24 is perspective view of a chisel according to another embodiment, the chisel including a body and a head coupled to the body.

FIG. 25 is an exploded view of the chisel of FIG. 24.

FIG. 26 is a cross-sectional view of the chisel of FIG. 24 along the line 26-26 of FIG. 24.

FIG. 27 is a front view of the chisel of FIG. 24.

FIG. 28 is a detailed side view of the chisel of FIG. 24.

FIG. 29 is a detailed perspective view of the chisel of FIG. 24.

FIG. 30 is a detailed perspective view of the body of FIG. 24.

FIG. 31 is a detailed perspective view of the head of the chisel of FIG. 24.

FIG. 32 is a detailed side view of the body of FIG. 24.

FIG. 33 is a detailed side view of the head of FIG. 24.

FIG. 34 is perspective view of a chisel according to another embodiment, the chisel including a body and a head coupled to the body.

FIG. 35 is an exploded view of the chisel of FIG. 34.

FIG. 36 is a detailed perspective view of the body of FIG. 34.

FIG. 37 is a detailed perspective view of the head of FIG. 34.

FIG. 38 is a detailed side view of the chisel of FIG. 34.

FIG. 39 is perspective view of a chisel according to another embodiment, the chisel including a body and a head coupled to the body.

FIG. 40 is an exploded view of the chisel of FIG. 39.

FIG. 41 is a detailed perspective view of the chisel of FIG. 39.

FIG. 42 is a cross-sectional view of the chisel of FIG. 39 along the line—42-42 of FIG. 41.

FIG. 43 is a detailed perspective view of the body of FIG. 39.

FIG. 44 is a detailed perspective view of the head of FIG. 39.

FIG. 45 is perspective view of a chisel according to another embodiment, the chisel including a body and a head coupled to the body.

FIG. 46 is an exploded view of the chisel of FIG. 45.

FIG. 47 is a detailed side view of the chisel of FIG. 45.

FIG. 48 is perspective view of a chisel according to another embodiment, the chisel including a body and a head coupled to the body.

FIG. 49 is a side view of the chisel of FIG. 48.

FIG. 50 is a detailed perspective view of the chisel of FIG. 48.

FIG. 51 is a detailed side view of the chisel of FIG. 48.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

This application discloses various embodiments for a chisel 10. The chisel 10 in each embodiment includes a body 20 including a first end 24, a second end 28 opposite the first end 24, and a longitudinal axis A extending from the first end 24 to the second end 28. The axis A may also be referred to as a longitudinal axis or a central longitudinal axis. The body 20 has a shank 32 that extends along the axis A and is positioned at the first end 24. The shank 32 is configured to be operably coupled to a chuck of a power tool (e.g., a drill, a rotary hammer, etc.). In the illustrated embodiments, the body 20 is substantially cylindrical. In some embodiments, the shank 32 has substantially the same diameter as rest of the body 20. In some embodiments, the shank 32 has a smaller diameter than the rest of the body 20, thereby creating a transition region 36 between the shank 32 and the rest of the body 20.

Additionally, the chisel 10 of each of the embodiments includes a head 50 that is coupled to the body 20 at the second end 28 and at least partially defines a working edge of the chisel 10. The head 50 may be coupled to the body 20 by any suitable means. For example, the head 50 may be coupled to the body 20 by brazing, welding, soldering, and the like. The body 20 is formed of a first material, and the head 50 is formed of a second material that is harder than the first material. In the illustrated embodiments, the body 20 is formed of tool steel, and the head 50 is formed of a carbide or high-speed steel (HSS). In other embodiments the body 20 may be formed of other suitable materials. In some embodiments, the body 20 may be formed of suitable materials having a hardness value ranging from 45 to 65, and the head 50 may be formed of other suitable materials having a hardness value ranging from 55 to 80.

Although features of the chisels are described below with reference to particular chisels, various features of the chisels may be used in combination with one another. In particular, features of one head may be applicable to or alternatively usable with another head.

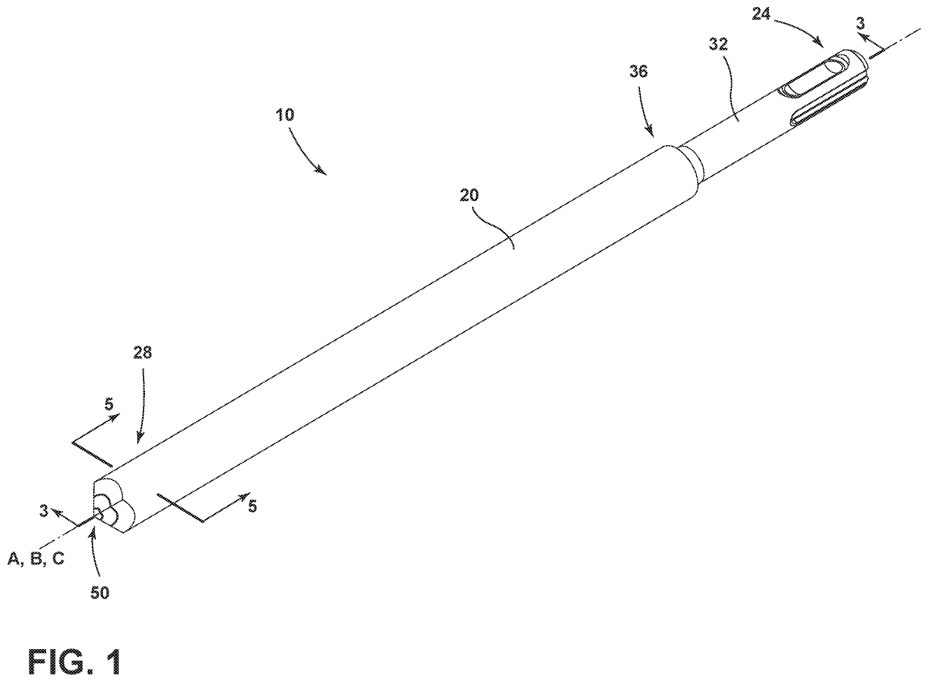

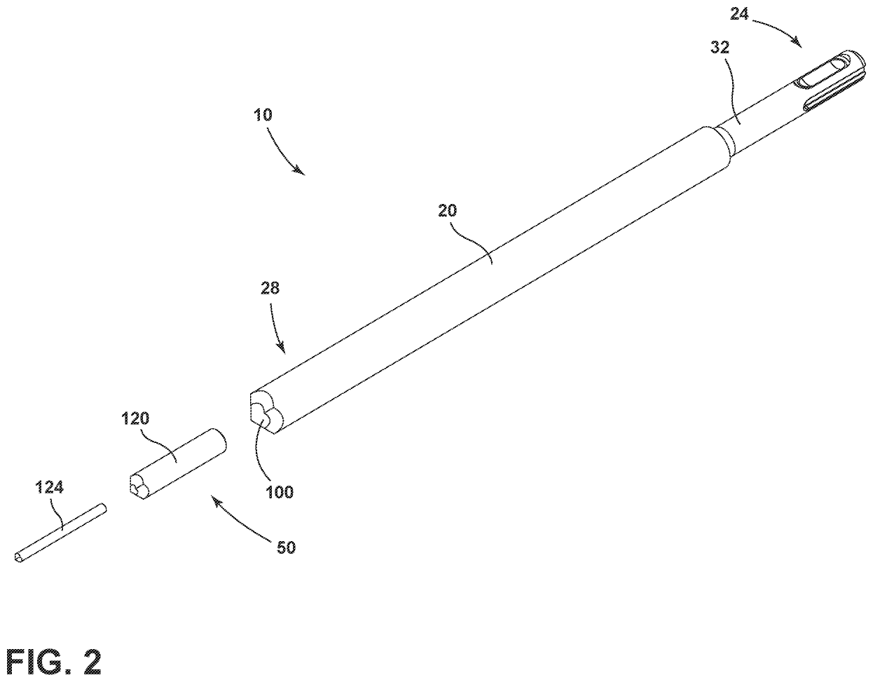

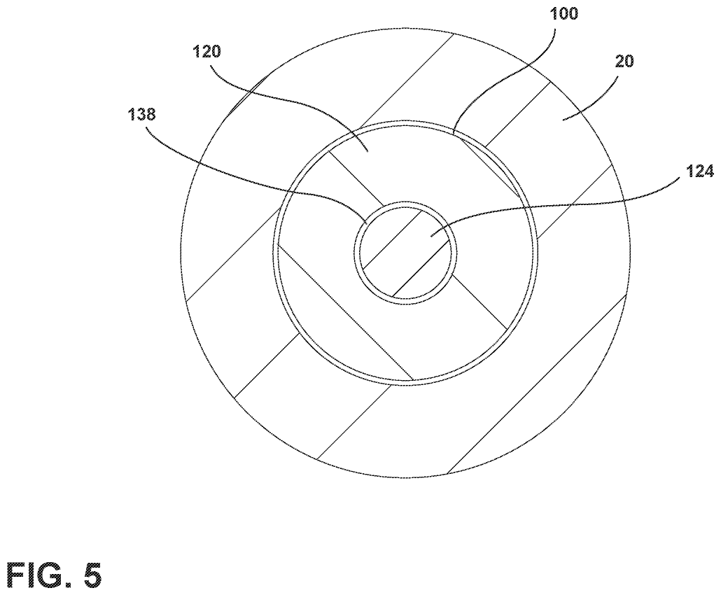

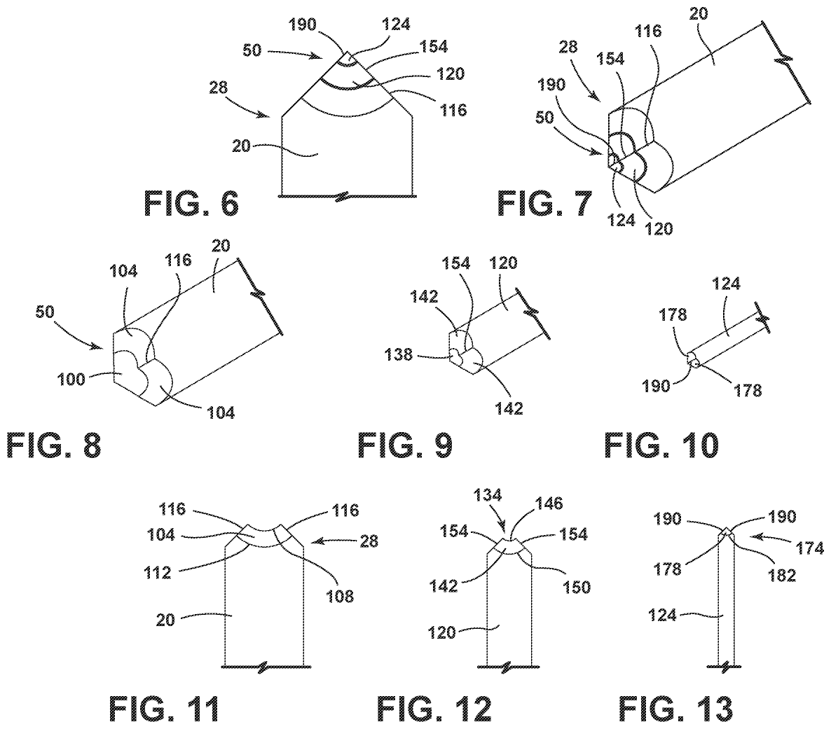

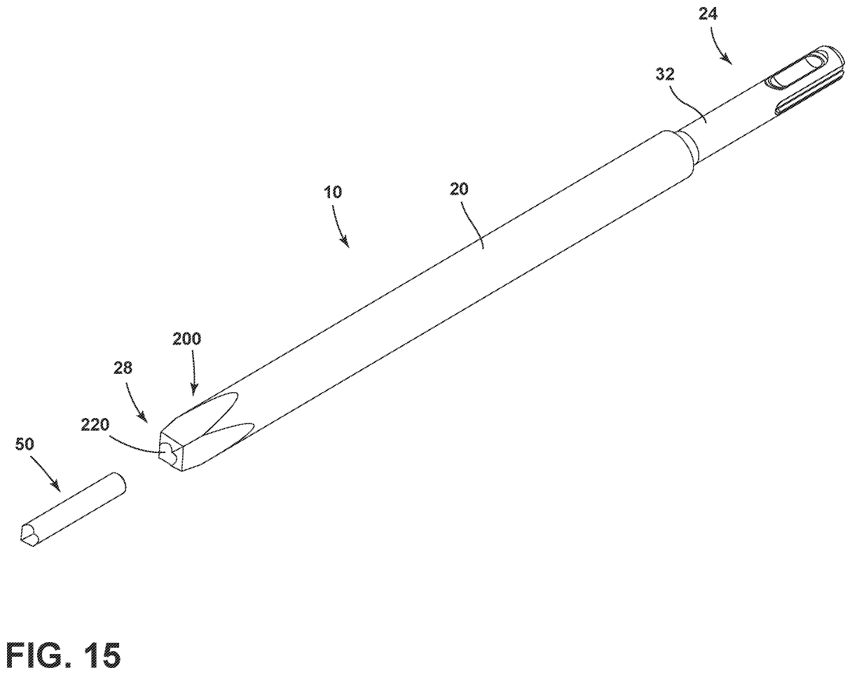

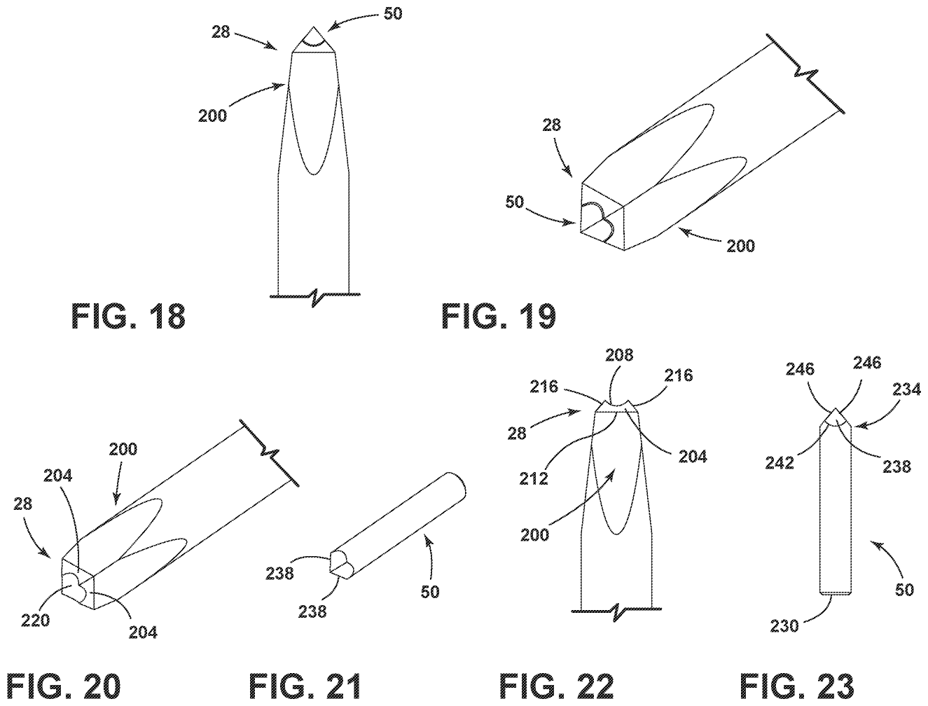

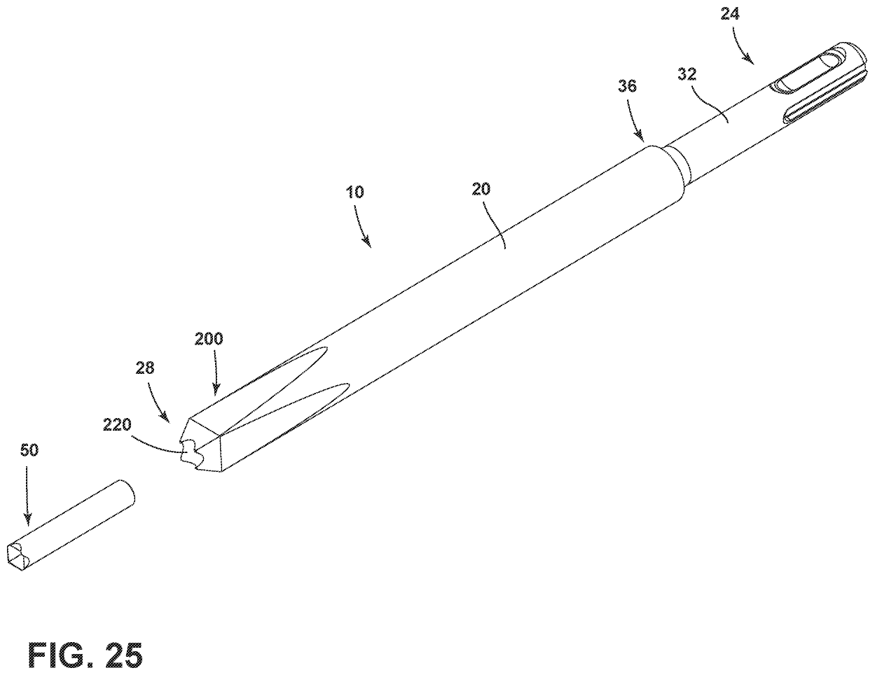

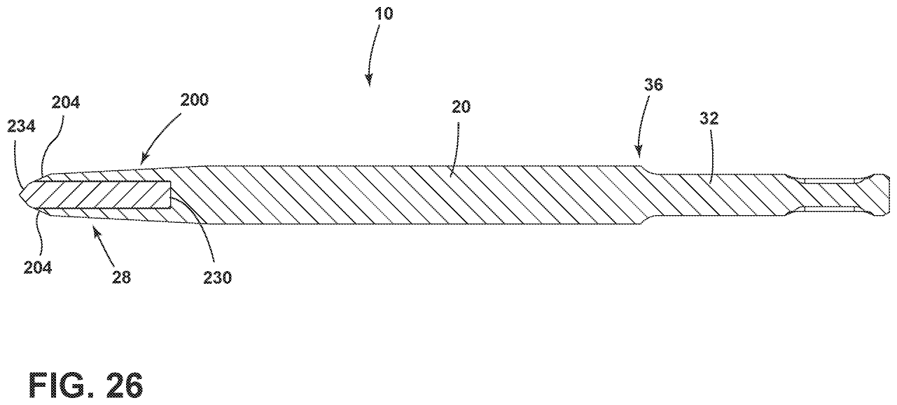

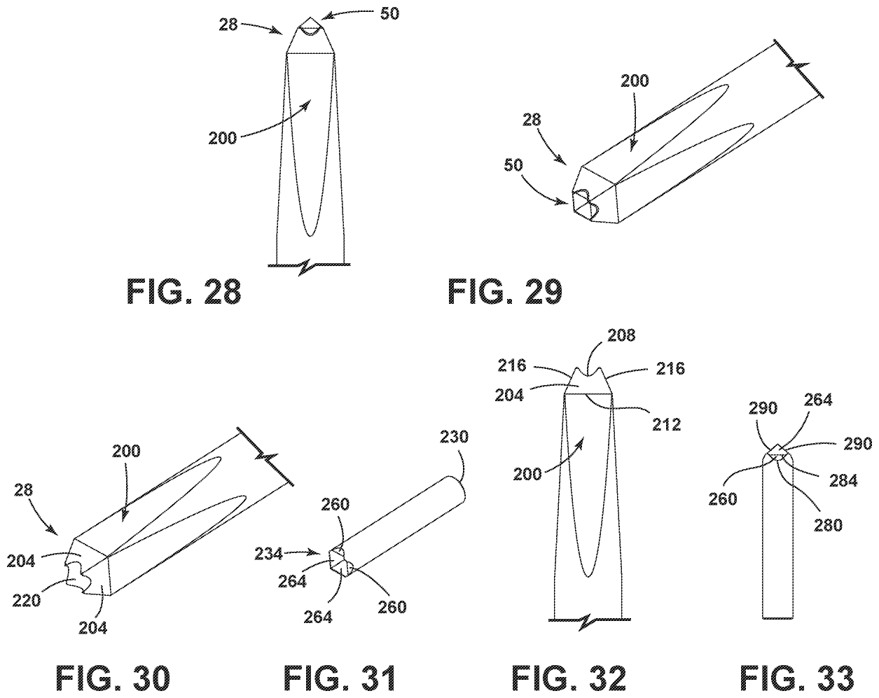

With specific reference to the embodiments of FIGS. 1-33, the body 20 includes a bore 100 (FIGS. 2, 15, 25) extending from the second end 28 in a direction toward the first end 24 along the axis A. The head 50 is at least partially received within the bore 100 and coupled to the second end 28 of the body 20.

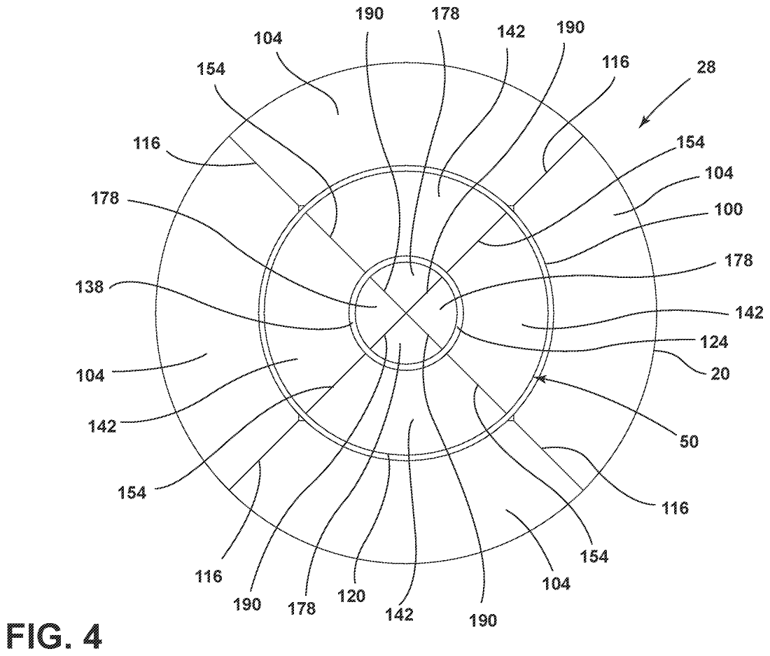

In the embodiment of FIGS. 1-13, the second end 28 of the body 20 includes a plurality of surfaces 104 (FIG. 4), each of which is substantially planar and defines a plane that is positioned at an oblique angle relative to the axis A. In the illustrated embodiment, the second end 28 of the body 20 includes four surfaces 104. In other embodiments, the body 20 may include fewer or more surfaces 104. Additionally, as shown relative to one of the plurality of surfaces 104 in FIG. 11, each of the plurality of surfaces 104 includes a first edge 108 (e.g., arcuate edge) positioned at the second end 28 and a second edge 112 (e.g., arcuate edge) that is spaced apart from the first edge 108 in the direction towards the first end 24. Each of first edges 108 define a portion of the bore 100. An adjoining edge 116 extends between adjacent surfaces 104. The adjoining edges 116 are oriented at an angle with respect to one another. In the illustrated embodiment, the adjoining edges 116 of each of the plurality of surfaces are oriented at an angle of about 90 degrees. In the illustrated embodiment, there are four surfaces 104, which are discrete surfaces. In other embodiments, there may be two or more discrete surfaces. In other embodiments, rather than having a plurality of surfaces 104 that are discrete, there may be a single surface that is substantially conical.

Further with respect to the embodiment of FIGS. 1-13, the head 50 includes a first member 120 and a second member 124.

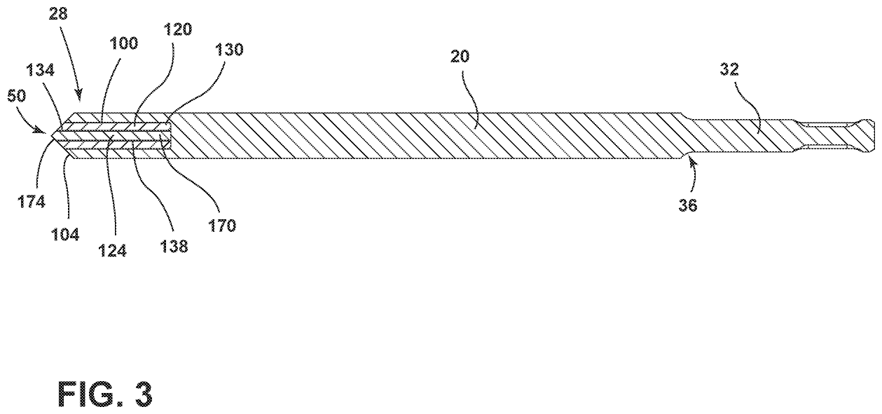

With respect to FIGS. 2, 3, 4, 6, 9, and 10, the first member 120 is shown in greater detail. The first member 120 includes a first end 130 (FIG. 3) that is positioned within the bore 100 of the body 20 and a second end 134 (FIG. 3) opposite the first end 130 that protrudes from the second end 28 of the body 20. An aperture 138 extends from the first end 130 to the second end 134 of the first member 120. The aperture 138 has an axis B that is coincident with the axis A of the body 20. The second end 134 of the first member 120 includes a plurality of surfaces 142, each of which is substantially planar and defines a plane that is positioned an oblique angle relative to the axis A. In the illustrated embodiment, the second end 134 of the first member 120 includes four surfaces 142. In other embodiments, the first member 120 may include fewer or more surfaces 142. Additionally, with respect to FIG. 12, each of the plurality of surfaces 142 includes a first edge 146 (e.g., arcuate edge) positioned at the second end 134 and a second edge 150 (e.g., arcuate edge) that is spaced apart from the first edge 146 in the direction towards the first end 130. Each of first edges 146 define a portion of the aperture 138. An adjoining edge 154 extends between adjacent surfaces 142. The adjoining edges 154 are oriented at an angle with respect to one another. In the illustrated embodiment, the adjoining edges 154 of each of the plurality of surfaces 142 are oriented at an angle of about 90 degrees. The angle between adjacent surfaces 142 of the first member 120 is substantially the same as the angle between adjacent surfaces 104 of the body 20. Accordingly, in the illustrated embodiment, each of the surfaces 142 of the first member 120 is configured to correspond with one of the plurality of surfaces 104 of the body 20. Moreover, as shown, the second edge 150 of each of the plurality of surfaces 142 of the first member 120 is configured to be positioned adjacent to the respective first edge 108 of the corresponding surface 104 of the body 20 and each of the adjoining edges 154 of the first member 120 are configured to be aligned with the respective adjoining edges 116 of the body 20, such that each of the plurality of surfaces 142 of the first member 120 is configured to be flush with the corresponding surface 104 of the body 20. In other words, the corresponding surfaces 104, 142 are generally coplanar. In the illustrated embodiment, the number of surfaces 142 corresponds to the number of surfaces 104 of the body 20. Accordingly, there are four surfaces 142, which are discrete surfaces. In other embodiments, there may be two or more discrete surfaces 142. In other embodiments, rather than having a plurality of surfaces 142 that are discrete, there may be a single surface that is substantially conical.

With respect to FIGS. 4, 6, 10, and 13, the second member 124 (FIG. 3) includes a first end 170 that is positioned within the aperture 138 of the first member 120 and a second end 174 opposite the first end 170 that protrudes from the second end 134 of the first member 120. A portion of the second end 174 of the second member 124 is axially separated from the axial span of the second end 28 and the first member 120 along the axis A. The second member 124 has an axis C that is configured to be coincident with the axes A, B of the body 20 and first member 120. The second end 174 of the second member 124 includes a plurality of surfaces 178, each of which is substantially planar and defines a plane that is positioned an oblique angle relative to the axis C. In the illustrated embodiment, the second end 174 of the second member 124 includes four surfaces 178. In other embodiments, the second member 124 may include fewer or more surfaces 178. Additionally, each of the plurality of surfaces 178 includes an edge 182 (e.g., an arcuate edge) that is spaced apart from the second end 174. An adjoining edge 190 extends between adjacent surfaces 178, and the adjoining edges 190 are coupled to one another at the second end 174 to collectively define a pointed end. The adjoining edges 190 are oriented at an angle with respect to one another. In the illustrated embodiment, the adjoining edges 190 of each of the plurality of surfaces 178 are oriented at an angle of about 90 degrees. Accordingly, in the illustrated embodiment, each of the surfaces 178 of the second member 124 is configured to correspond with one of the plurality of surfaces 142 of the first member 120. Moreover, as shown, the edge 182 of each of the plurality of surfaces 178 of the second member 124 is configured to be positioned adjacent to the respective first edge 146 of the corresponding surface 142 of the first member 120 and each of the adjoining edges 190 of the second member 124 is configured to be aligned with the respective adjoining edges 154 of the first member 120, such that each of the plurality of surfaces 178 of the second member 124 is configured to be flush with the corresponding surface 142 of the first member 120. In other words, the corresponding surfaces 142, 178 are generally coplanar. The body 20, the first member 120, and the second member 124 thereby form a pyramidal shape. Additionally, each of the surfaces 142, 178 of the first and second members 120, 124 collectively define the working edges 154, 190 of the head 50 of the chisel 10. In the illustrated embodiment, the number of surfaces 178 corresponds to the number of surfaces 142 of the first member 120. Accordingly, there are four surfaces 142, which are discrete surfaces. In other embodiments, there may be two or more discrete surfaces. In other embodiments, rather than having a plurality of surfaces 142 that are discrete, there may be a single surface that is substantially conical.

In some embodiments, the first member 120 and the second member 124 may be constructed of the same material. In some embodiments, the first member 120 and the second member 124 may be constructed of different materials. In such embodiments, the first member 120 and the second member 124 may have different hardness values. For example, the second member 124 may be formed of a harder material than the first member 120. In other embodiments, the first or second member 120, 124 may be the same material as the body 20. Therefore, the chisel 10 may be formed from two or more materials (one for the body 20 and one of the first and second member 120, 124 and one the other of for the first member 120 and one for the second member 124), each having the same or different hardness values. Alternatively, the chisel 10 may be formed from three or more materials (one for the body 20, one for the first member 120, and one for the second member 124), each having the same or different hardness values. Moreover, in some embodiments, the first member 120 may be movable (e.g., telescopically movable) relative to the body 20 and/or the second member 124 may be movable (e.g., telescopically movable) relative to the first member 120.

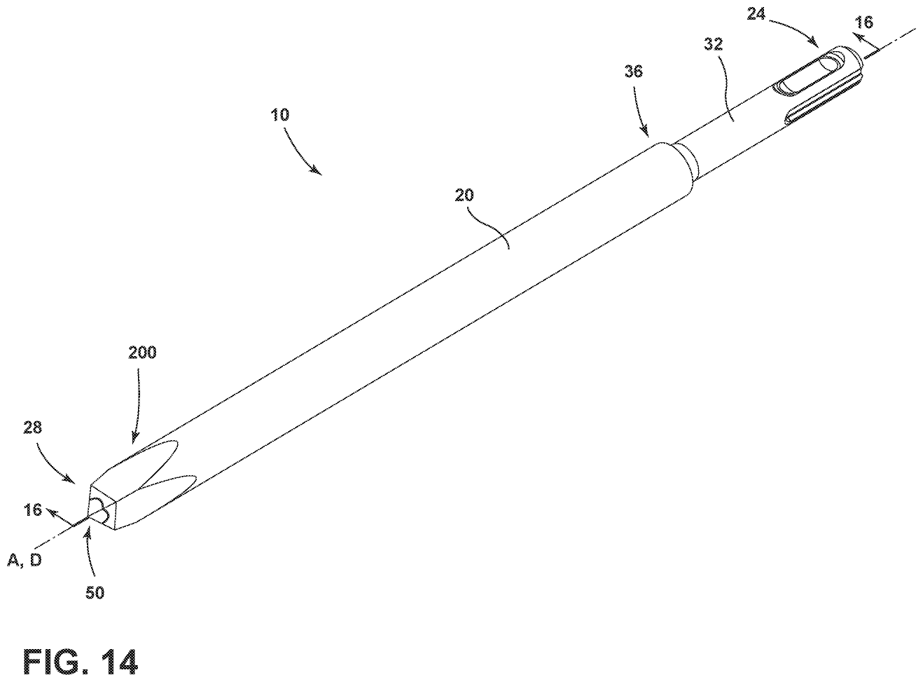

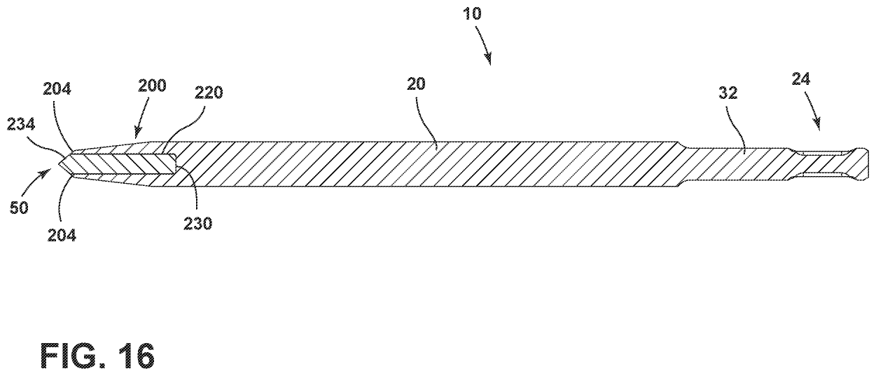

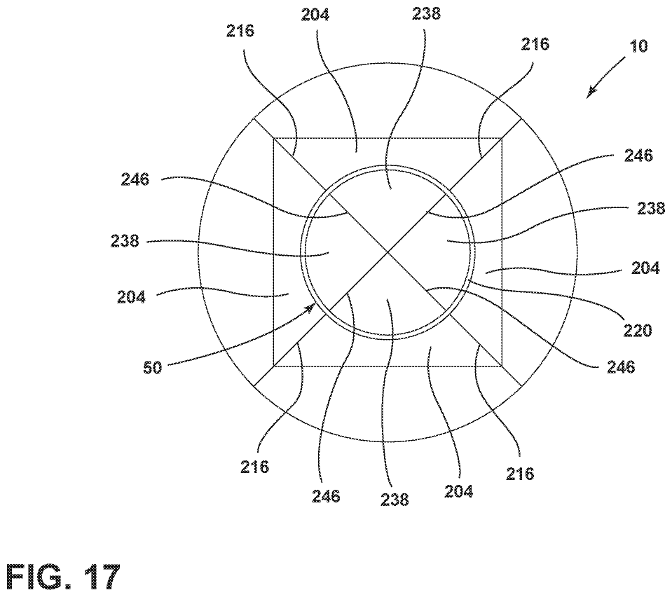

In the embodiment of FIGS. 14-23, the body 20 includes a substantially tapered portion 200 (FIG. 16) that extends from a location between the first end 24 and the second end 28 towards the second end 28. The tapered portion 200 is generally oriented at a first angle oblique relative to the axis A. With respect to FIGS. 17-20 and 22, the body 20 further includes a plurality of surfaces 204, each of which is substantially planar and defines a plane that is positioned a second oblique angle relative to the axis A. In the illustrated embodiment, the body 20 includes four surfaces 204. In other embodiments, the body 20 may include fewer or more surfaces 204. Each surface 204 corresponds to and transitions from one of the surfaces that makes up the tapered portion 200. In the illustrated embodiment, the first oblique angle and the second oblique angle are different. The second oblique angle is generally larger than the first oblique angle. Additionally, with respect to FIG. 22, each of the plurality of surfaces 204 includes an edge 208 (e.g., an arcuate edge) positioned at the second end 28 and an edge 212 (e.g., a straight edge) that is spaced apart from the edge 208. The edge 212 is positioned between the respective surface 204 and the tapered portion 200 of the body 20. An adjoining edge 216 extends between adjacent surfaces 204. The adjoining edges 216 are oriented at an angle with respect to one another. In the illustrated embodiment, the adjoining edges 216 of each of the plurality of surfaces 204 are oriented at an angle of about 90 degrees. Each of the edges 208 define a portion of a bore 220 that extends from the second end 28 in a direction toward the first end 24 along the axis A. In the illustrated embodiment, there are four surfaces 204, which are discrete surfaces. In other embodiments, there may be two or more discrete surfaces. In other embodiments, rather than having a plurality of surfaces 204 that are discrete, there may be a single surface that is substantially conical.

Further with respect to FIGS. 17-19, 21, and 23, the head 50 includes a first end 230 that is positioned within the bore 220 of the body 20 and a second end 234 opposite the first end 230 that protrudes from the second end 28 of the body 20. An axis D extends between the first end 230 and the second 234 and is configured to be coincident with the axis A of the body 20. The second end 234 of the head 50 includes a plurality of surfaces 238, each of which is substantially planar and defines a plane that is positioned an oblique angle relative to the axis D. In the illustrated embodiment, the second end 234 of the head 50 includes four surfaces 238. In other embodiments, the head 50 may include fewer or more surfaces 238. Each of the plurality of surfaces 238 includes an edge 242 (e.g., arcuate edge) that is spaced apart from the second end 234. An adjoining edge 246 extends between adjacent surfaces 238, and the adjoining edges 246 are coupled to one another at the second end 234 to collectively define a pointed end. The adjoining edges 246 are oriented at an angle with respect to one another. In the illustrated embodiment, the adjoining edges 246 of each of the plurality of surfaces 238 are oriented at an angle of about 90 degrees. Accordingly, in the illustrated embodiment, each of the surfaces 238 of the head 50 is configured to correspond with one of the plurality of surfaces 204 of the body 20, and each of the surfaces 238 of the head 50 is configured to extend from the second end 28 of the body 20. Moreover, as shown, the edge 242 of each of the plurality of surfaces 238 of the head 50 is configured to be positioned adjacent to the respective edge 208 of the corresponding surface 204 of the body 20 and each of the adjoining edges 246 of the head 50 are configured to be aligned with the respective adjoining edges 216 of the body 20, such that each of the plurality of surfaces 238 of the head 50 is configured to be flush with the corresponding surface 204 of the body 20. In other words, the surfaces 204, 238 are generally coplanar. The body 20 and the head 50 thereby form a pyramidal shape. Additionally, each of the surfaces 238 collectively define the working edges of the head 50 of the chisel 10. In the illustrated embodiment, the number of surfaces 238 corresponds to the number of surfaces 204 of the body 20. Accordingly, there are four surfaces 238, which are discrete surfaces. In other embodiments, there may be two or more discrete surfaces. In other embodiments, rather than having a plurality of surfaces 238 that are discrete, there may be a single surface that is substantially conical.

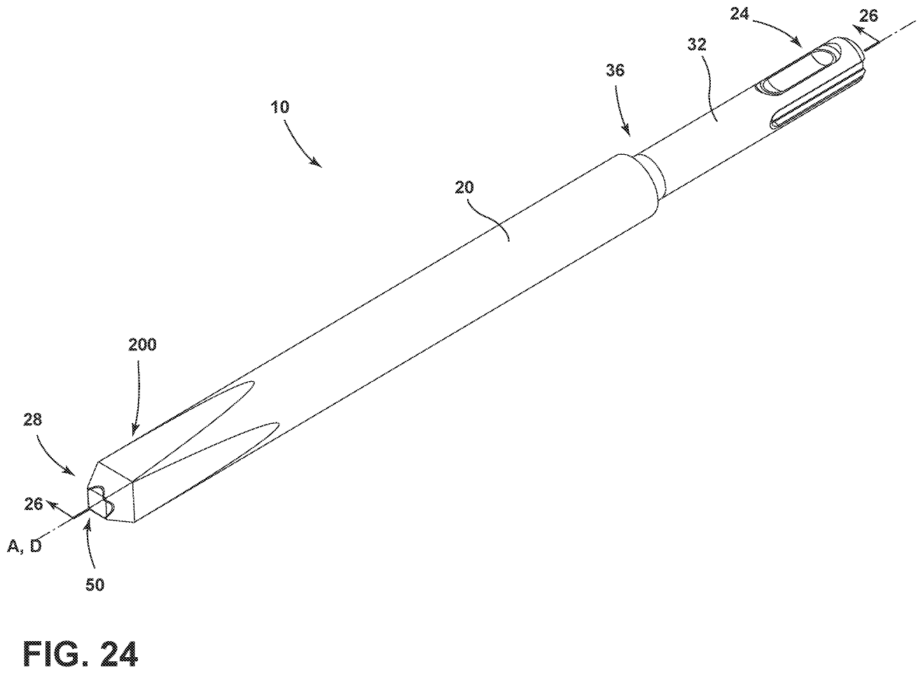

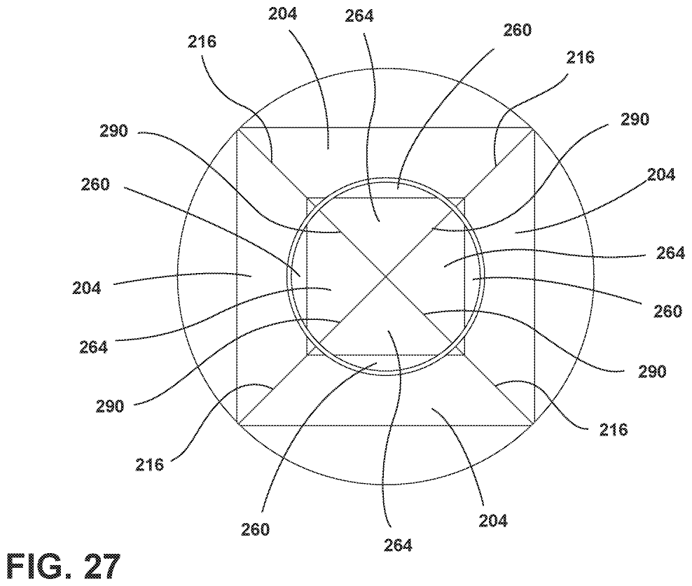

The embodiment of FIGS. 24-33 is similar to that of the embodiment of FIGS. 14-23 and therefore like structure will be identified using like reference numerals and only the differences discussed herein. With respect to FIGS. 27-29, 31, and 33, the head 50 includes a plurality of first surfaces 260 and a plurality of second surfaces 264.

Each of the plurality of first surfaces 260 is substantially planar and defines a plane that is positioned at a first oblique angle relative to the axis D. In the illustrated embodiment, the head 50 includes four first surfaces 260. In other embodiments, the head 50 may include fewer or more first surfaces 260. Additionally, each of the plurality of first surfaces 260 is substantially semicircular and includes an edge 280 (e.g., a straight edge) and an edge 284 (e.g., arcuate edge) that that intersects the edge 280 at opposite ends thereof. The edge 284 is configured to be positioned adjacent to the respective edge 208 of the body 20. In some embodiments, each of the plurality of first surfaces 260 may be flush with a corresponding surface 204 of the body 20. In other embodiments, each of the plurality of first surfaces 260 may be slightly recessed relative to a corresponding surface 204 of the body 20.

Each of the plurality of second surfaces 264 is substantially planar and defines a plane that is positioned a second oblique angle relative to the axis D. The second oblique angle of plurality of second surfaces 264 is different than the first oblique angle of the plurality of first surfaces 260. In the illustrated embodiment, the head 40 includes four second surfaces 264. In other embodiments, the head 50 may include fewer or more second surfaces 264. Additionally, each of the plurality of second surfaces 264 includes the edge 284 of a corresponding one of the plurality of first surfaces 260 and adjoining edges 290 that are positioned between adjacent second surfaces 264. The adjoining edges 290 are oriented at an angle with respect to one another. In the illustrated embodiment, the adjoining edges 290 of each of the plurality of surfaces 264 are oriented at an angle of about 90 degrees. As shown, in the illustrated embodiment, each of the surfaces 264 of the head 50 is configured to extend from the second end 28 of the body 20. Moreover, as shown, each of the adjoining edges 290 of the head 50 are configured to be aligned with the respective adjoining edges 216 of the body 20. Additionally, each of the surfaces 264 collectively define the working edges 290 of the head 50 of the chisel 10.

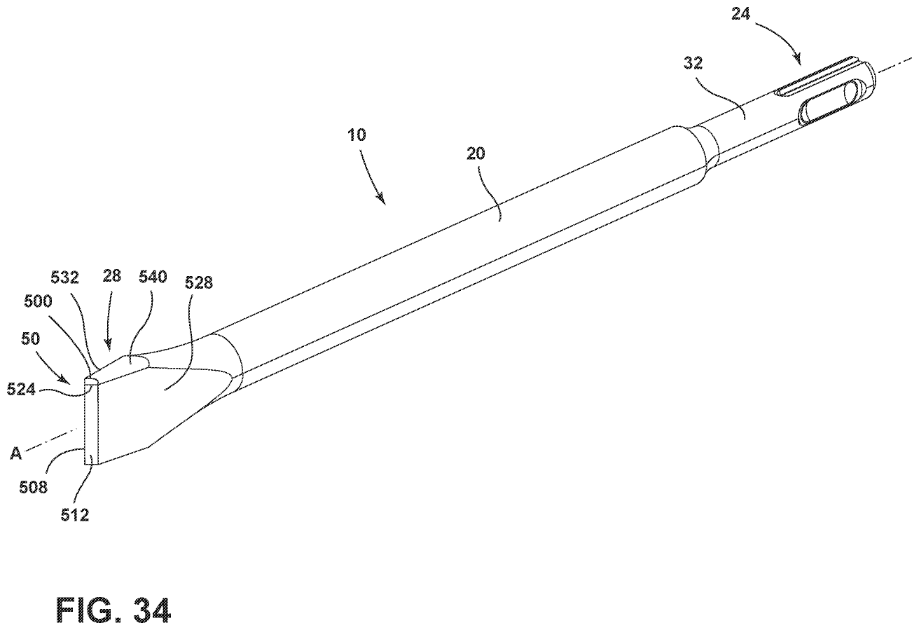

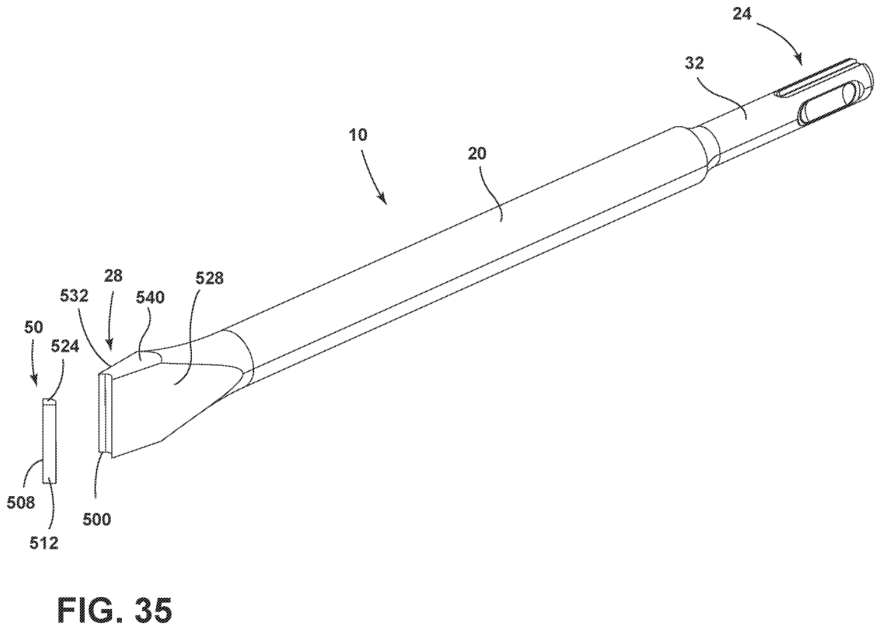

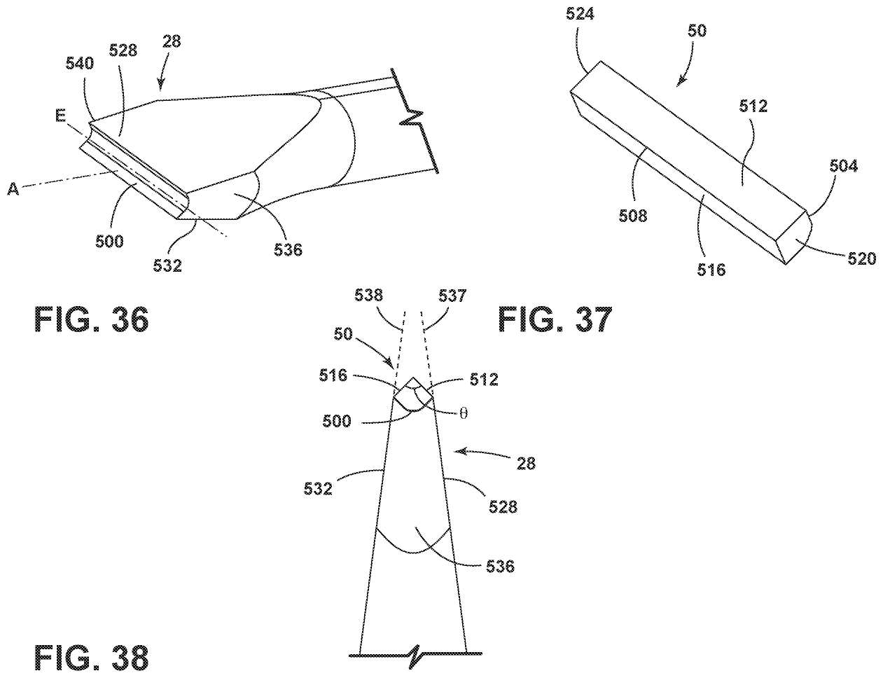

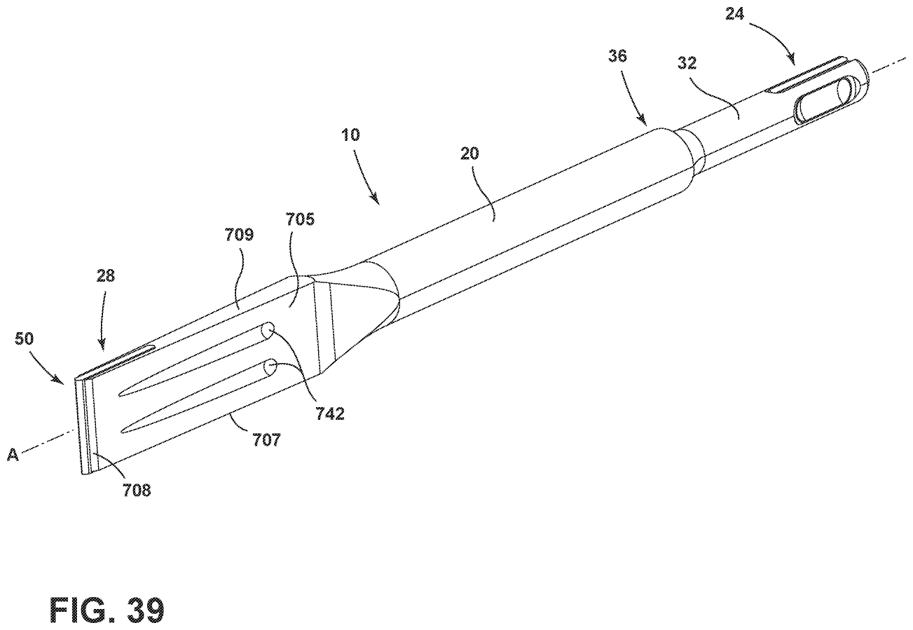

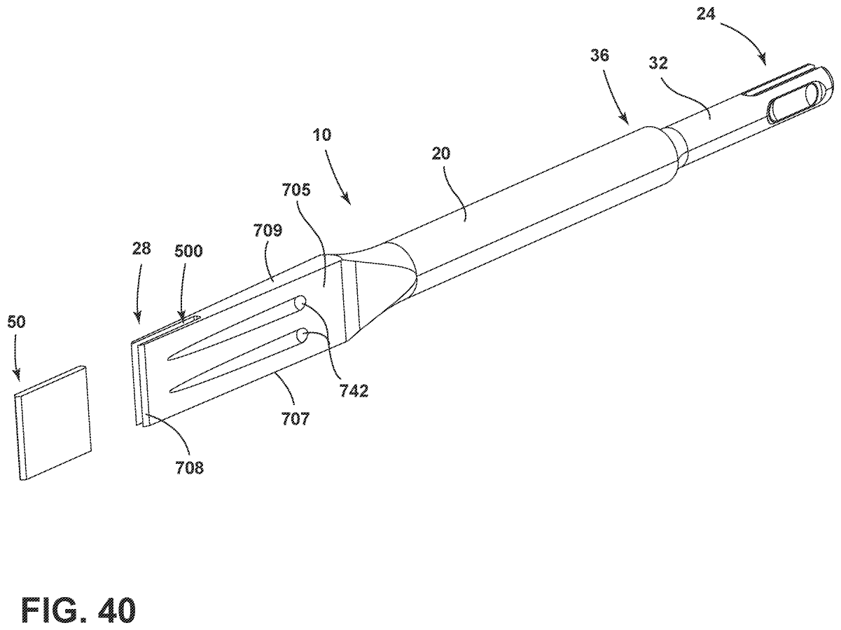

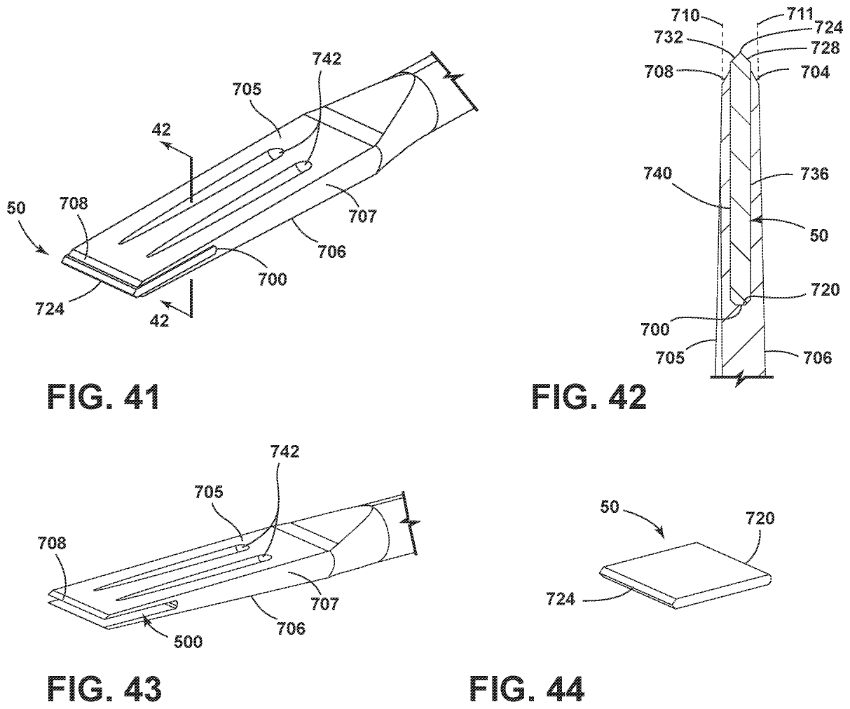

With reference to FIGS. 34-45, the head 50 defines a portion of a flat chisel and is at least partially received within a channel 500 of the second end 28 of the body 20.

With specific reference to the embodiment of FIGS. 34-44, the channel 500 is positioned at the second end 28 of the body 20 and extends along an axis E that is perpendicular to the axis A. In the illustrated embodiment, the channel 500 is a substantially semicircular shape. In other embodiments, the channel 500 may have other shapes, such as squared, triangular, and the like. The channel 500 has substantially the same width as the second end 28 of body 20. The head 50 is an elongate wedge-shaped head 50. The head 50, like the channel 500, has substantially the same width as the second end 28 of body 20. More specifically, the head 50 defines a first, coupling surface 504, a straight edge 508 that defines the working edge of the chisel 10, and a plurality of working surfaces 512, 516, 520, 524 that extends between the coupling surface 504 and the straight edge 508. In some embodiments, the straight edge 508 may be an arcuate or rounded edge. The straight edge 508 is aligned with the axis A. The coupling surface 504 is complementary to and received by the channel 500. Therefore, because the channel 500 is semicircular, the coupling surface 504 is arcuate. The first surface 512 is positioned adjacent a first planar side 528 (i.e., a first side) of the second end 28 of the body 20, the second surface 516 is positioned adjacent to a second planar side 532 (i.e., a second side) of the second end 28 of the body 20, the third surface 520 is positioned adjacent to a third side 536 of the body 20, and the fourth surface 534 is positioned adjacent to a fourth side 540 of the body 20. The first and second sides 528, 532 of the second end 28 define a first plane 537 and a second plane 538, respectively. The channel 500 is formed in an edge of the second end 28 between the first and second planar sides 528, 532 and extends between the third and fourth side 536, 540. The head 50 is received in the channel 500 and is positioned between the planes 537, 538. The first surface 512 and the second surface 516 are coupled to one another at the straight edge 508 and are angularly separated by a margin Θ. In some embodiments, the margin Θ is approximately 90 degrees. The first surface 512 and the second surface 516 also extend continuously between the third surface 520 and the fourth surface 534. In the illustrated embodiment, the first surface 512 and the second surface 516 are positioned at a generally perpendicular angle relative to one another, although in other embodiments, this angle may be greater than or less than ninety degrees.

With specific reference to FIGS. 34-44, the body 20 defines a substantially rectangular channel 500. As shown, the channel 500 extends from the second end 28 of the body 20 towards the first end 24 of the body 20. A width of the channel 500 is the same as a width of the body 20. A recessed surface 700 of channel 500 is a coupling surface. In the illustrated embodiment, the recessed surface 700 is substantially arcuate. In other embodiments, the recessed surface 700 can have other shapes (e.g., flat, stepped, irregular, etc.). The body 20 defines a first chamfered or angled edge 704 and a second chamfered or angled edge 708 at the second end 28. The second end 28 of the body 20 defines a first planar side 705, a second planar side 706, a third side 707, and a fourth side 709. The first and second sides 705, 706 of the second end 28 define a first plane 710 and a second plane 711, respectively. The channel 500 is formed in an edge of the second end 28 between the first and second plans 710, 711 and extends between the third and fourth side 707, 709. The head 50 is received in the channel 500 and is positioned between the planes 710, 711.

The head 50 includes a plate that is received within channel 500 and projects from the second end 28 of the body 20. The plate includes a first end 720 and a second end 724 opposite the first end 720. The first end 720 has a coupling surface that is complementary to the coupling surface 700 of the channel 500. In this case, the coupling surface of the first end 720 is substantially arcuate. The second end 724 defines a straight, working edge of the chisel 10. The head 50 further includes a first angled surface 728, a second angled surface 732, a first planar surface 736, and a second planar surface 740. The first angled surface 728 and the second angled surface 732 are coupled to one another at the working edge and extend from the working edge toward the first end 720. The first angled surface 728 and the second angled surface 732 define an angle therebetween. The first and second planar surfaces 736, 740 extend from the respective first and second angled 728, 732 surfaces to the first end 720. The first and second planar surfaces 736, 740 include a portion that are axially separated from an axial span of the second end 28 of the body 20. The first and second planar surfaces 736, 740 include depressions 742 (e.g., fluted geometry) to enhance removal of material. The head 50 is positioned in the channel 500 such that the coupling surface of the first end 720 is received in the coupling surface 700 and the first and second angled surfaces 728, 732 extend from the second end 28 of the body 20. Relatively small sections of the planar surfaces 736, 740 also extend out of the channel 500 beyond the second end 28 of the body 20. As shown, the first and second chamfered edges 704, 708 of the body 20 are positioned adjacent to the respective planar surfaces 736, 740 of the head 50 at a location between the angled surfaces 728, 732 and the first end 720.

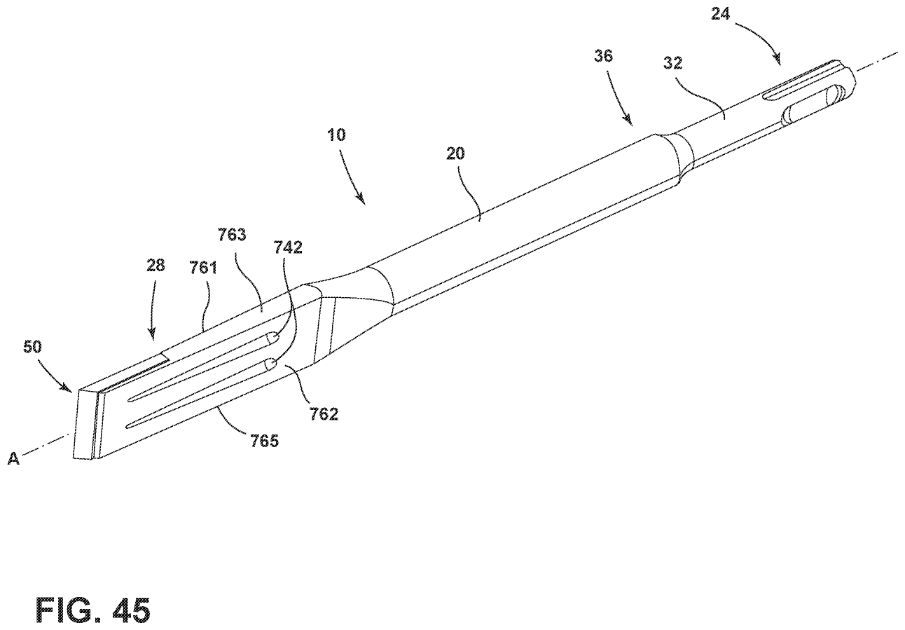

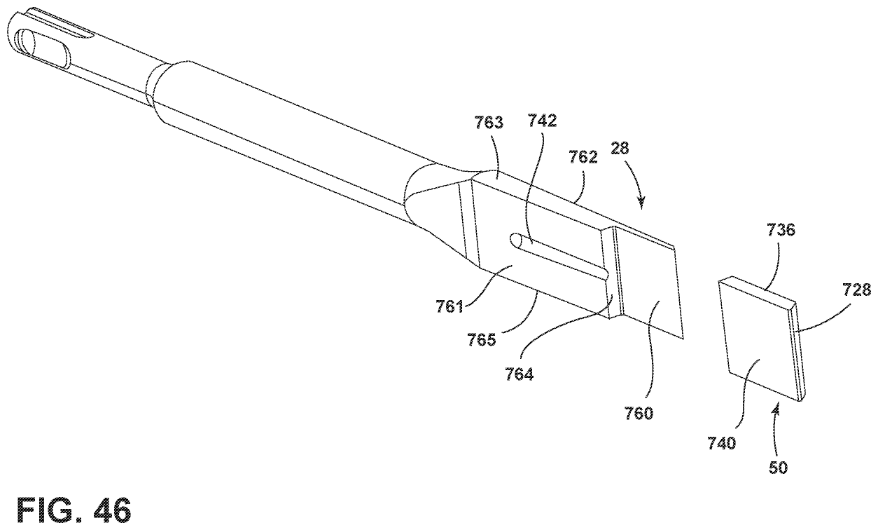

In the embodiment illustrated in FIGS. 34-44, the straight edge of the head 50 is generally in the same plane as the axis A. In other embodiments, the head 50 may alternatively or additionally include a working edge that is offset relative to a plane defined by the axis A. That is, the head 50 or an edge thereof may be offset relative to the axis A of the body 20. One example of a chisel with a head with a working edge that is offset relative to a plane defined by axis A is shown in FIGS. 45-47. As shown, the body 20 includes a recess 760, rather than a channel 500, with a coupling surface 764. The second end 28 of the body 20 defines a first planar side 761, a second planar side 762, a third side 763, and a fourth side 765. The first and second sides 761, 762 of the second end 28 define a first plane 766 and a second plane 767, respectively. The recess 760 is formed in the second end 28 between the first and second planes 766, 767 and extends between the third and fourth side 763, 765. The head 50 is received in the recess 760 and is positioned between the planes 766, 767. Also, the head 50 includes a plate that is received within recess 760 and projects from the second end 28 of the body 20. The plate includes a first end 720 and a second end 724 opposite the first end 720. The first end 720 has a coupling surface that is complementary to the coupling surface 764 of the recess 760. The second end 724 defines a straight, working edge of the chisel 10. This head 50 further only includes the first angled surface 728, while the second angled surface 732 is omitted, a first planar surface 736, and a second planar surface 740. The second planar surface 740 is flush to the first plane 766. The first angled surface 728 is coupled to the second planar surface 740 at the working edge and extends from the working edge toward the first end 720. The first angled surface 728 and the second planar surface 740 define an angle therebetween. The first angled surface 728 is angled toward the first plane 766. The first and second planar surfaces 736, 740 extend from the first angled surface 728 to the first end 720. The head 50 is positioned in the recess 760 such that the coupling surface of the first end 720 is received in the coupling surface 764 and the first angled surface 728 extends from the second end 28 of the body 20. As shown, the second planar surface 740 is generally flush with a planar side 761 of the body 20. Relatively small sections of the first planar surface 736 also extend out of the recess 760 beyond the second end 28 of the body 20. As shown, the first chamfered edge 704 of the body 20 are positioned adjacent to the second planar surface 740 of the head 50 at a location between the angled surface 728 and the first end 720. As shown, a plane that extend through a center of the head 50 is coincident with the axis A, but a plane that extends through the working edge of the head 50 (and is coincident, in this case, with the second planar surface 740) is also offset from the plane extending through the axis A. This embodiment is merely exemplary. That is, the head 50 or the working edge of the head 50 may implemented in other ways. Such a chisel may have one side used for scraping and another side is used for chipping, for example.

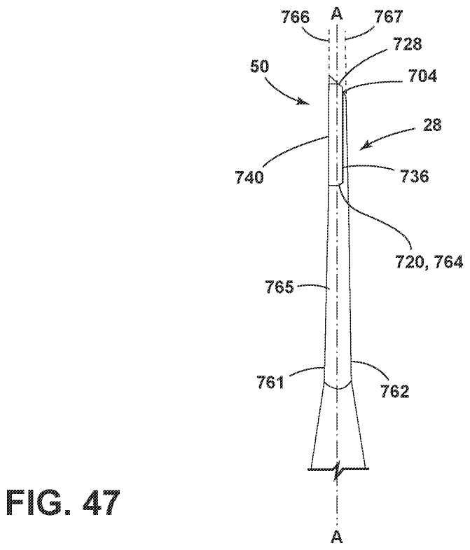

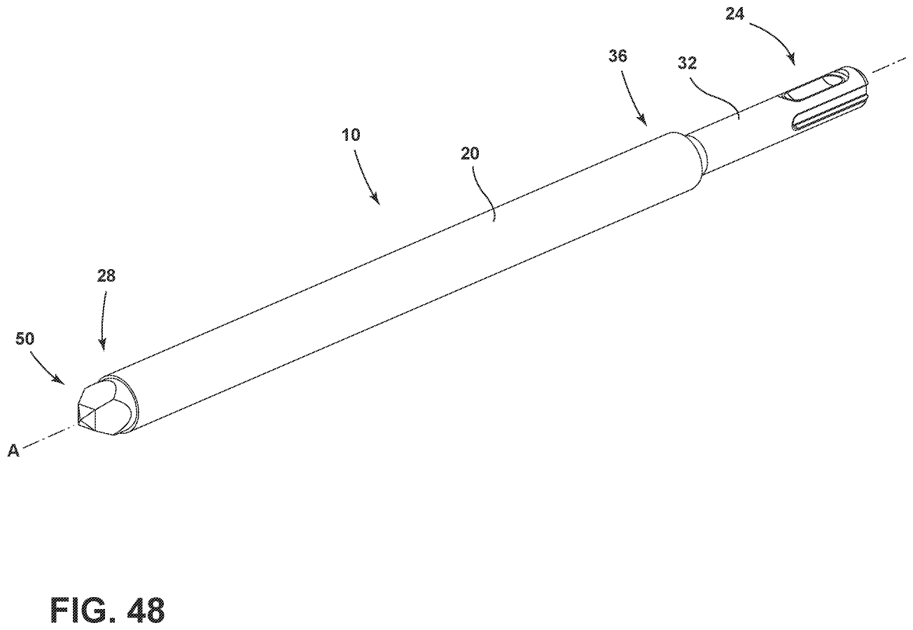

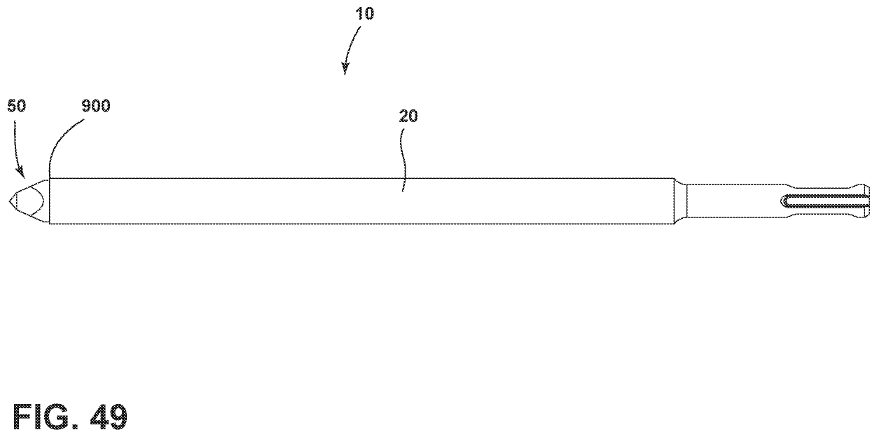

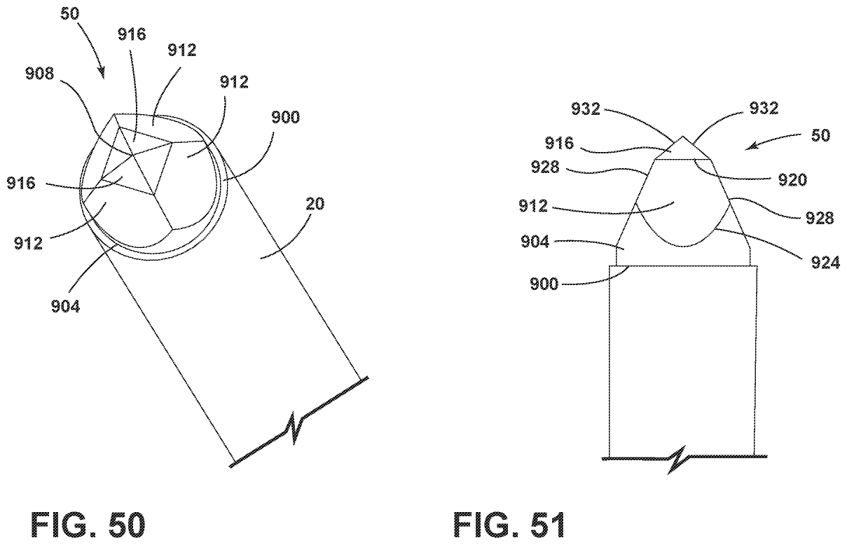

With respect to the embodiment of FIGS. 48-51, the chisel 10, including the body 20 and the head 50, are entirely formed of carbide, HSS, or other suitable material having a hardness value of between 45 and 80. As shown, in the embodiment of FIGS. 48-51, the body 20 include a lip 900 at the second end 28 thereof. The lip 900 has a diameter that is larger than a diameter of the head 50. In other embodiments, the second end 28 may have a diameter that is equal to the diameter of the head 50, such that the lip 900 is omitted and the head 50 is flush with the body 20. The head 50 includes a first end 904 coupled to (or integrally formed with) the second end 28 of the body 20 and a second end 908 opposite the first end 904. The first end 904 includes a substantially circular cross-section, and the second end 908 defines the working edges. With respect to FIGS. 47-48 in particular, the head 50 includes a plurality of first surfaces 912 and a plurality of second surfaces 916. In the illustrated embodiment, the head 50 includes four first surfaces 912, and four second surfaces 916. In other embodiments, the head 50 may include fewer or more first surfaces 912 and/or second surfaces 916. In still other embodiments, rather than having a plurality of surfaces 912 that are discrete, there may be a single surface that is substantially conical.

Each of the plurality of first surfaces 912 is substantially planar and defines a plane that is positioned at a first oblique angle relative to the axis A. Additionally, each of the plurality of first surfaces 912 includes a first edge 920 and a second edge 924 spaced apart from the first edge 920. In the illustrated embodiment, the first edge 920 is a straight edge, while the second edge 924 is an arcuate edge. Adjoining edges 928 extend between an end of each first edge 920 and an end of each second edge 924.

Each of the plurality of second surfaces 916 is substantially planar and defines a plane that is positioned a second oblique angle relative to the axis A. The second oblique angle of plurality of second surfaces 916 is different than the first oblique angle of the plurality of first surfaces 912. Additionally, each of the plurality of second surfaces 916 includes the first edge 920 of a corresponding one of the plurality of first surfaces 912 and adjoining edges 932 that are positioned between adjacent second surfaces 912. The adjoining edges 932 are oriented at an angle with respect to one another. In the illustrated embodiment, the adjoining edges 932 of each of the plurality of surfaces 912 are oriented at an angle of about 90 degrees. The adjoining edges 932 of the second surfaces 916 intersect with the adjoining edge 928 of the first surfaces 912. Additionally, each of the second surfaces 916 collectively define the working edges 932 of the head 50 of the chisel 10.

Although the invention has been described in detail with reference to certain preferred embodiments, variations and modifications exist within the scope and spirit of one or more independent aspects of the invention as described.

What is claimed is:

1. A chisel comprising:
a body formed of a first material and including
a first end having a shank,
a second end having a first planar side that defines a first plane, a second planar side that is opposite the first planar side and defines a second plane, a third side extending between the first planar side and the second planar side, and a fourth side that is opposite the third side and extending between the first planar side and the second planar side,
a channel formed in an edge of the second end between the first planar side and the second planar side, the channel extending from the third side to the fourth side, and
a longitudinal axis extending through the first end and the second end; and
a head formed of a second material that is harder than the first material, the head received in the channel, positioned between the first and second planes, extending continuously between the third side and the fourth side, and defining a working surface of the chisel.

2. The chisel of claim 1, wherein the channel has a semicircular shape, and wherein the head defines a coupling surface that is complementary to the semicircular shape of the channel.

3. The chisel of claim 2,
wherein the working surface is a first working surface that extends from the coupling surface,
wherein the head defines a second working surface extending from the coupling surface, and
wherein the first working surface and second working surface converge toward the longitudinal axis to define a working edge of the chisel.

4. The chisel of claim 3, wherein the first working surface and the second working surface are angled by 90 degrees relative to each other.

5. The chisel of claim 1,
wherein the channel has a substantially rectangular shape,
wherein the head is plate-shaped, and
wherein the head includes a first end positioned within the channel and a second end that projects from the second end of the body.

6. The chisel of claim 5,
wherein the working surface is a first working surface and the head defines a second working surface,
wherein the first working surface and the second working surface converge toward the longitudinal axis to define a working edge of the chisel,
wherein the head includes a first planar surface that extends from the first working surface,
wherein the head also includes a second planar surface that is opposite the first planar surface and extends from the second working surface, and
wherein the first and second planar surfaces are at least partially received in the channel.

7. The chisel of claim 6, wherein a portion of the first and second planar surfaces protrudes axially beyond the second end of the body along the longitudinal axis.

8. The chisel of claim 5, wherein the first end of the head includes chamfered edges.

9. The chisel of claim 1, wherein first planar side and the second planar side include depressions.

10. A chisel comprising:
a body formed of a first material and including
a first end having a shank,
a second end having a first planar side that defines a first plane, a second planar side that is opposite the first planar side and defines a second plane, a third side extending between the first planar side and the second planar side, and a fourth side that is opposite the third side and extending between the first planar side and the second planar side,
a recess formed in the second end between the first plane and second plane,
a longitudinal axis extending through the first end and the second end; and
a plate formed of a second material that is harder than the first material, the plate received in the recess, positioned between the first and second planes, and defining a working surface of the chisel.

11. The chisel of claim 10, wherein the plate is disposed between the first planar side and the second planar side.

12. The chisel of claim 10, wherein the plate defines a first wall that is flush with the first plane.

13. The chisel of claim 10, wherein the working surface of the chisel is angled toward the first plane.

14. The chisel of claim 10,
wherein the working surface is a first working surface and the head defines a second working surface, and
wherein the working surface and second working surface converge toward the longitudinal axis to define a working edge of the chisel.

15. A chisel comprising:
a body formed of a first material and including a first end having a shank, a second end opposite the first end, and a longitudinal axis extending through the first end and the second end, the second end defining a bore extending in a direction toward the first end along the longitudinal axis, the second end also defining a first working surface of the chisel;
a first member formed of a second material that is harder than the first material, the first member positioned within the bore and defining an aperture, the first member defining a second working surface of the chisel; and
a second member formed of a third material that is harder than the first material, the second member positioned within the aperture, the second member defining a third working surface of the chisel.

16. The chisel of claim 15, wherein the third material is harder than the second material.

17. The chisel of claim 15, wherein the aperture extends continuously through the first member from a first end of the first member to a second end of the first member, and wherein the second member extends through an entirety of the aperture.

18. The chisel of claim 15, wherein the second end of the body, the first member, and the second member axially overlap along the longitudinal axis.

19. The chisel of claim 15, wherein a portion of the second member protrudes axially beyond the first member and the body along the longitudinal axis.

20. The chisel of claim 15, wherein the first working surface, the second working surface, and the third working surface are parallel and converge toward the longitudinal axis.
